(19) United States
(12) Patent Application Publication
(10) Pub. No.: US 2006/0152475 A1
(43) Pub. Date: Jul. 13, 2006

(54) Electrophoretic display panel

(75) Inventors: Guofu Zhou, Eindhoven (NL); Mark Thomas Johnson, Eindhoven (NL); Neculai Ailenei, Heerlen (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/562,529

(22) PCT Filed: Jun. 30, 2004
(86) PCT No.: PCT/IB04/51071

§ 371 Date: Dec. 28, 2005

(30) Foreign Application Priority Data
Jul. 4, 2003 (EP) 03101999.5

(51) Int. Cl. G09G 3/34

(52) U.S. Cl. 345/107

(57) ABSTRACT

An electrophoretic display panel (1), comprises drive means (100), for controlling the potential difference of each picture element (2) to be a reset potential difference having a reset value and a reset duration for enabling particles (6) to substantially occupy one of the extreme positions. The reset pulses are applied in two or more pulses separated by a non-zero time interval during a reset period (Pᵣₑₛₑₜ).

The invention relates to an electrophoretic display panel, comprising:

an electrophoretic medium comprising charged particles;

a plurality of picture elements;

electrodes associated with each picture element for receiving a potential difference; and

drive means, the drive means being arranged for controlling the potential difference of each of the plurality of picture elements

to be a reset potential difference having a reset value and a reset duration during a reset period, and subsequently

to be a grey scale potential difference for enabling the particles to occupy the position corresponding to image information.

The invention also relates to a method for driving an electrophoretic display device in which method reset pulses are applied to elements of the display device, prior to application of grey scale data.

The invention further relates to drive means for driving such an electrophoretic display panel.

An embodiment of the electrophoretic display panel of the type mentioned in the opening paragraph is described in International Patent Application WO 02/073304.

In the described electrophoretic display panel, each picture element has, during the display of the picture, an appearance determined by the position of the particles. The position of the particles depends, however, not only on the potential difference but also on the history of the potential difference. As a result of the application of the reset potential difference the dependency of the appearance of the picture element on the history is reduced, because particles substantially occupy one of the extreme positions before a grey scale potential difference is applied. Thus the picture elements are each time reset to one of the extreme states. Subsequently, as a consequence of the picture potential difference, the particles occupy the position to display the grey scale corresponding to the image information. “Grey scale” is to be understood to mean any intermediate state. When the display is a black and white display, “grey scale” indeed relates to a shade of grey, when other types of colored elements are used ‘grey scale’ is to be understood to encompass any intermediate state in between extreme states.

When the image information is changed the picture elements are reset. The inventors have realized that during application of the reset voltages the image on the display may show erratic changes in the image which are unappealing to a viewer. In particular the change over from one image to another may be quite erratic.

It is an object of the invention to provide a display panel of the kind mentioned in the opening paragraph which is able to provide a smoother change over from one image to another.

The object is thereby achieved that the drive means are further arranged for application of the reset potential difference for resetting a picture element from an optical state to an extreme optical state in two or more pulses separated by a non-zero time interval during a reset period.

Resetting the picture elements to one of the extreme states requires for different picture elements the application of a reset potential. The total duration of the application of the reset potential difference is best made a function of the difference between the optical state, which may be an intermediate optical state, i.e. a grey scale before resetting and the extreme optical state to which the picture elements is to be reset, i.e. when a picture element which is white has to be reset to a black state, i.e. from an extreme optical state to an extreme optical state, the reset potential difference is applied during a relatively long time period, whereas if a picture element is to be reset from a dark grey to a black state, i.e. from an intermediate optical state to an extreme optical state, the reset potential difference need only to be applied for a relatively shorter time period. Thus there is a maximum application time for the reset potential (the reset time period). Applying for each element which is to be reset from an optical state, e.g. an intermediate grey scale to an extreme position (e.g. from a grey value to a black state) the reset potential difference in one pulse leads, as the inventors have realized, to a shock effect upon change-over from one image to another, especially if the image differ considerably, which shock effect is unappealing to the viewer. Distributing of the reset potential difference over two or more pulses separated by a non-zero time interval leads to a smoother transition from one image to a next image.

Preferably the drive means are arranged for application of the reset potential difference for resetting a picture element from one optical state to an extreme optical state in two or more pulses during the reset period (Pᵣₑₛₑₜ) for all image transitions with a total reset potential application time shorter than a maximum and longer than a minimum.

The transition from a grey level equivalent to or very close to an extreme state may, within the concept of the invention, still be applied in one short pulse, or one very long pulse, as long as for the transition of at least one intermediate optical state, and preferably the majority of intermediate optical states, to an extreme optical state two or more pulses separated by a non-zero time interval are used. Preferably for all transitions having a total application time longer than a lower threshold and shoter than an upper threshold two or more pulses are used. Application of the reset pulse is often bound by fixed time periods (e.g. the frame time) wherein the reset period is an integral number (e.g. N) times the fixed time periods. Transitions requiring very short total pulse (0, 1 or possibly 2 times the fixed time period) may be done in one un-split pulse, as may be long pulses for transitions requiring N or N−1 times the fixed time period.

The two or more pulses preferably have the same polarity.

In embodiments the reset potential difference is at least for some transitions distributed over more than two pulses. This leads to an even further reduction of the shock effect.

In embodiments reset potential is distributed over two pulses. This type of scheme requires the least energy.

Preferably the drive means are arranged for application of the reset potential difference in two or more pulses wherein the applied pulses have, for the transition from at least one intermediate optical state to an extreme state, substantially equal time duration.

The pulses are of substantially equal length leading to a relatively smooth image transition.

Preferably the drive means are arranged for application of the reset potential difference in two or more pulses wherein , for the transition of at least one intermediate optical state to an extreme optical state, the pulses are separated by at least two non-zero time intervals, and the time intervals are of substantially equal length.

Making the time intervals between pulses, especially if the pulses themselves have equal length, of the same length leads to a very smooth image transition.

The invention is in particular advantageous when the drive means are able to control the reset pulses so that at least for some transitions overreset is applied.

It is furthermore favorable, if the drive means are further able to control for each picture element the potential difference to be a sequence of preset potential differences before being the reset potential difference, the sequence of preset potential differences having preset values and associated preset durations, the preset values in the sequence alternating in sign, each preset potential difference representing a preset energy sufficient to release particles present in one of said extreme positions from their position but insufficient to enable said particles to reach the other one of the extreme positions. As an advantage, the sequences of preset potential differences reduce the dependency of the appearances of the picture elements on the history of the potential difference.

In accordance with the present invention, there is provided a method for driving an electrophoretic display device comprising:

an electrophoretic medium comprising charged particles;

a plurality of picture elements, in which method reset pulses are applied to elements of the display device, prior to application of grey scale data, for resetting picture elements characterized in that the reset potential difference for resetting a picture element from an optical state to an extreme optical state is applied in two or more pulses separated by a non-zero time interval during a reset period (Pᵣₑₛₑₜ).

Also in accordance with the present invention, there is provided drive means for driving an electrophoretic display panel, said display panel comprising:

an electrophoretic medium comprising charged particles;

a plurality of picture elements; and

electrodes associated with each picture element for receiving a potential difference; said drive means being arranged for controlling the potential difference of each picture element

to be a reset potential difference having a reset value and a reset duration for enabling particles to substantially occupy one of the extreme positions, and subsequently

to be a picture potential difference for enabling the particles (6) to occupy the position corresponding to the image information, said drive means being further arranged for application of the reset potential difference for resetting a picture element from one optical state to an extreme optical state in two or more pulses separated by a non-zero time interval during a reset period (Pᵣₑₛₑₜ).

These and other aspects of the display panel of the invention will be further elucidated and described with reference to the drawings, in which:

FIG. 1 shows diagrammatically a front view of an embodiment of the display panel;

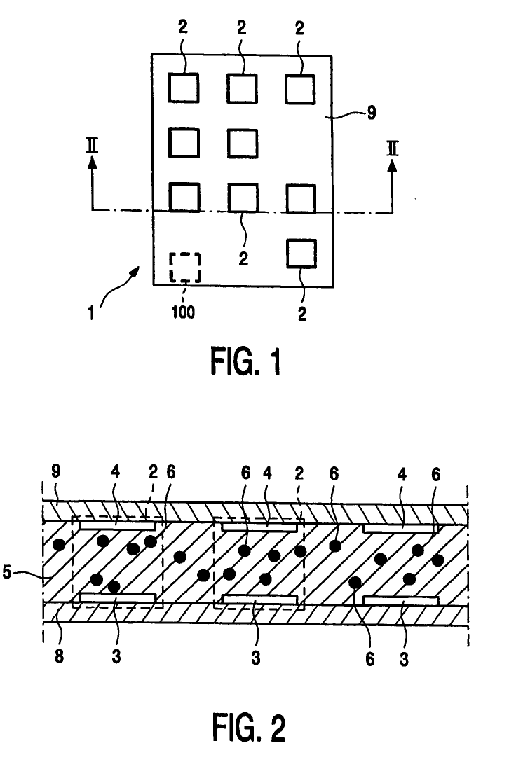

FIG. 2 shows diagrammatically a cross-sectional view along II-II in FIG. 1;

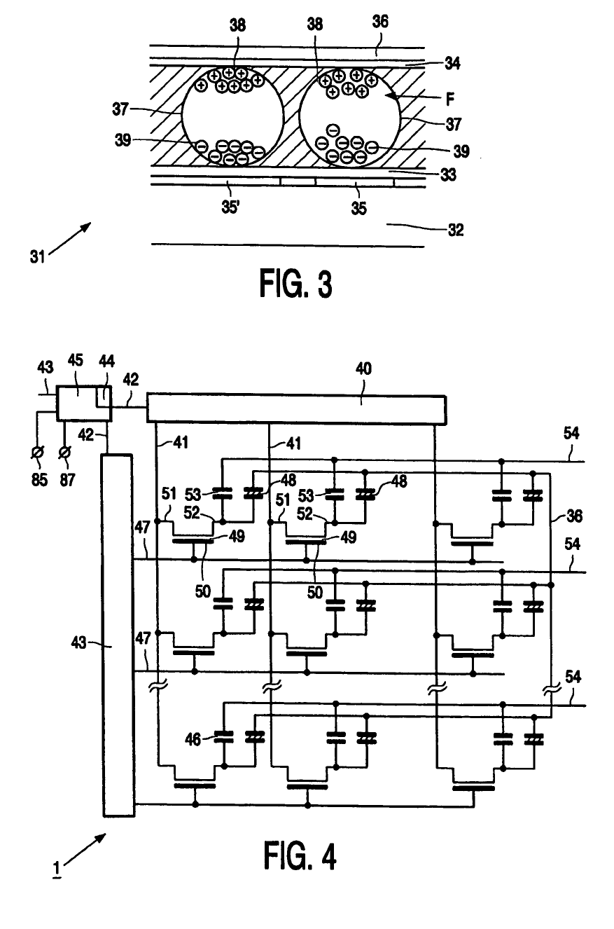

FIG. 3 shows diagrammatically a cross section of a portion of a further example of an electrophoretic display device;

FIG. 4 shows diagrammatically an equivalent circuit of a picture display device of FIG. 3;

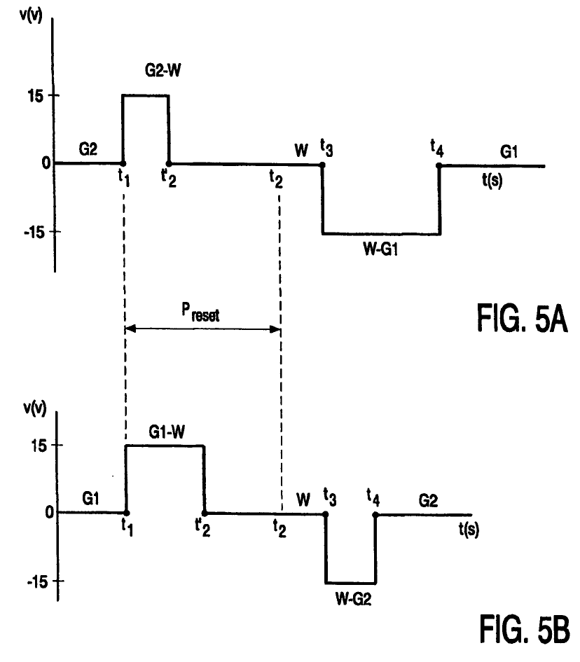

FIG. 5A shows diagrammatically the potential difference as a function of time for a picture element of the subset for the embodiment;

FIG. 5B shows diagrammatically the potential difference as a function of time for a picture element of the subset in a variation of the embodiment;

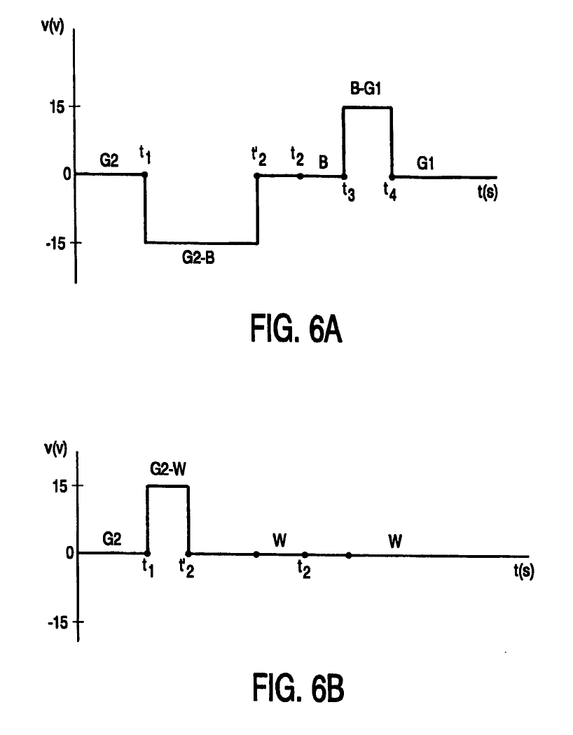

FIG. 6A shows diagrammatically the potential difference as a function of time for a picture element of the subset in another variation of the embodiment;

FIG. 6B shows diagrammatically the potential difference as a function of time for another picture element of the subset in the same variation of the embodiment associated with FIG. 5A;

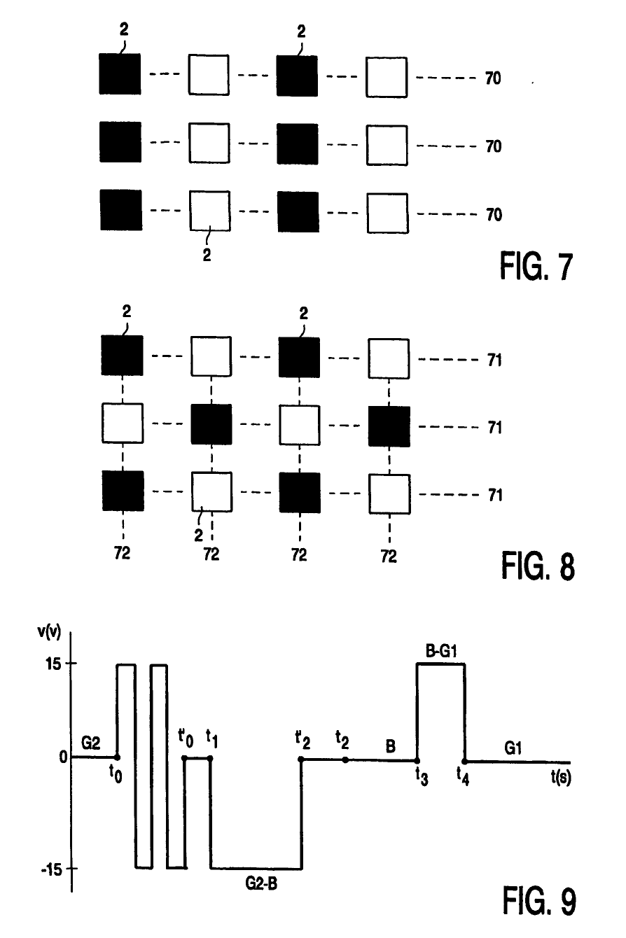

FIG. 7 shows the picture representing an average of the first and the second appearances as a result of the reset potential differences in another variation of the embodiment, and

FIG. 8 shows the picture representing an average of the first and the second appearances as a result of the reset potential differences in another variation of the embodiment.

FIG. 9 shows diagrammatically the potential difference as a function of time for a picture element of the subset in another variation of the embodiment.

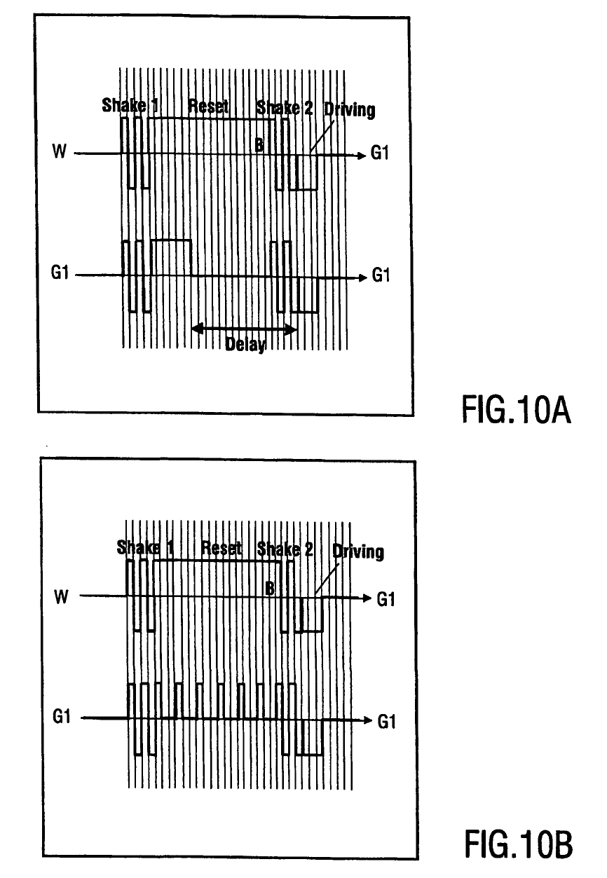

FIGS. 10A and 10B illustrate schemes without splitting of the reset pulse (FIG. 10A) and with splitting of the reset pulse in accordance with an embodiment of the invention (FIG. 10B).

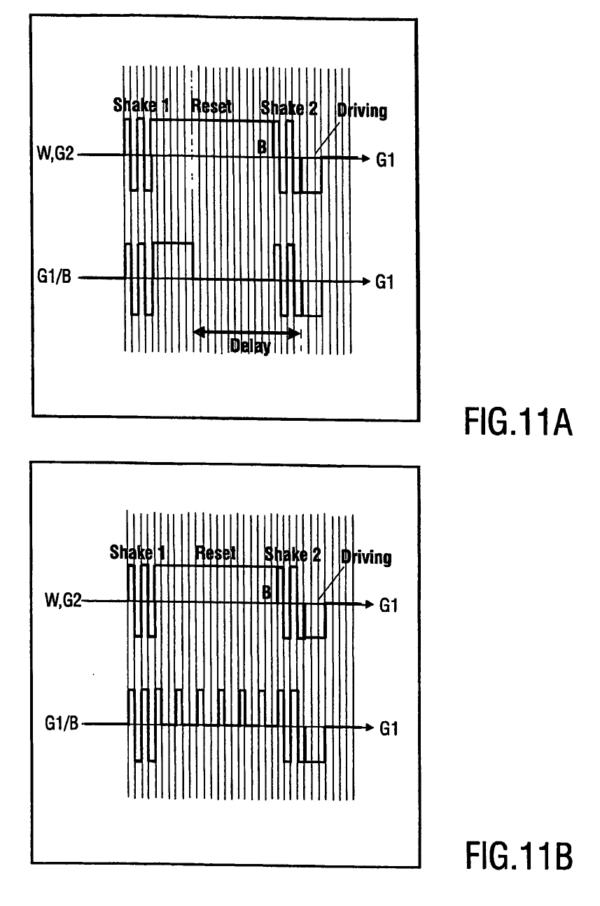

FIGS. 11A and 11B illustrate further schemes without splitting of the reset pulse (FIG. 11A) and with splitting of the reset pulse in accordance with an embodiment of the invention (FIG. 11B).

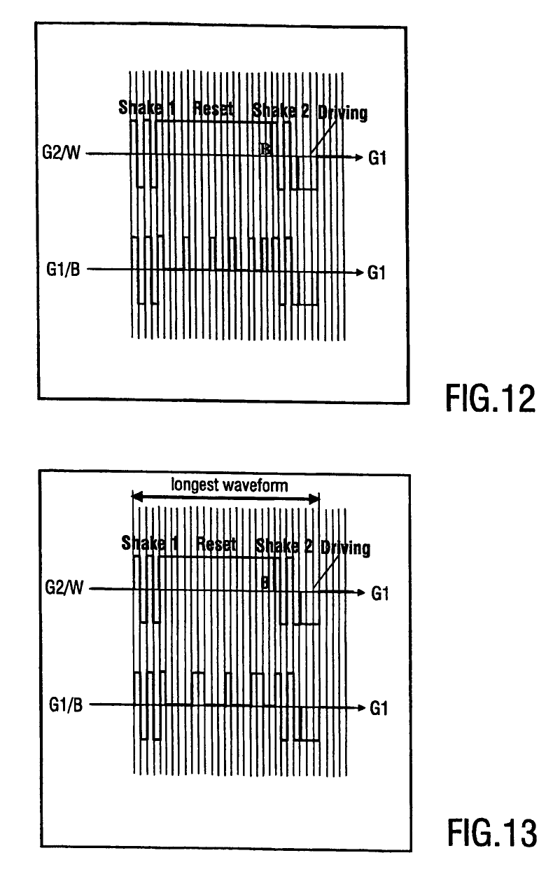

FIGS. 12, 13, 14A, 14B and 15 illustrates further examples of schemes in which the reset pulse is split.

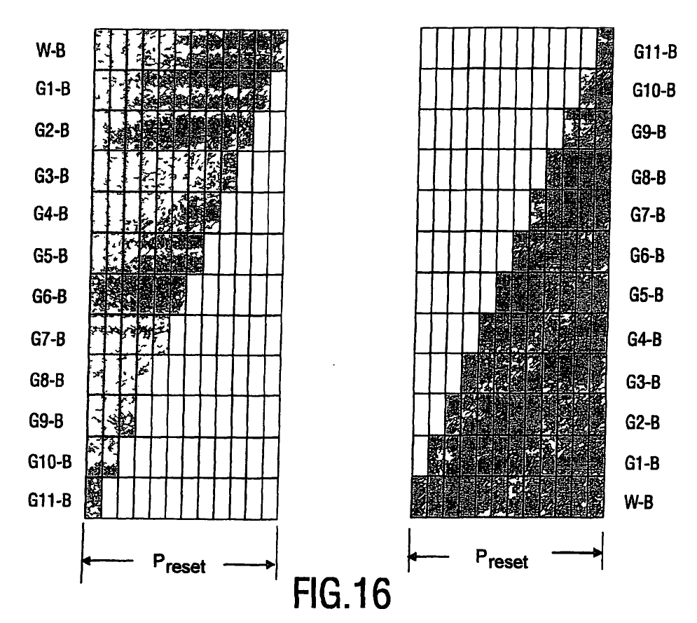

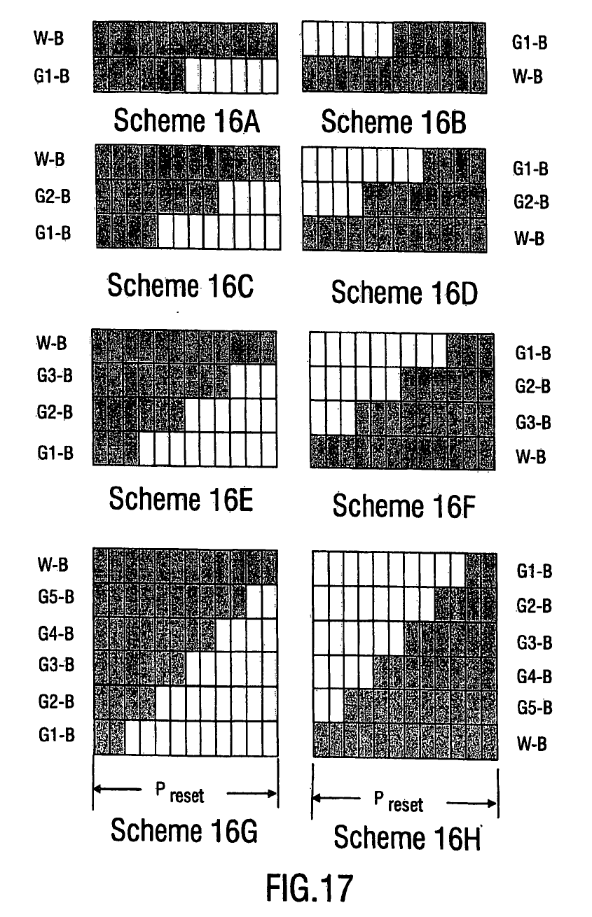

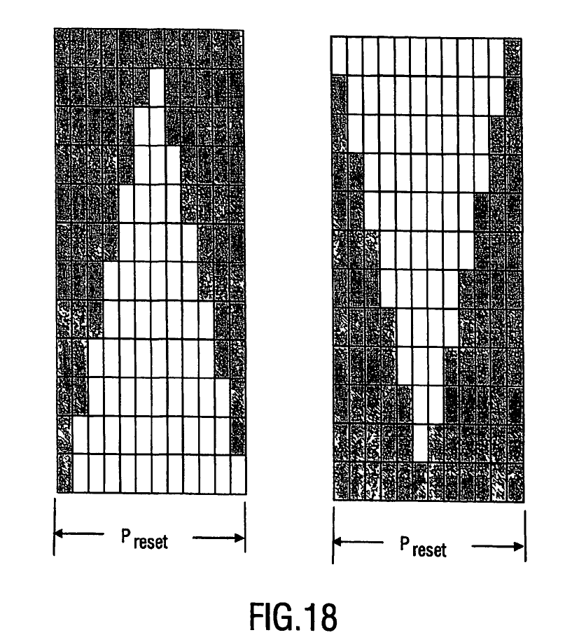

FIGS. 16 up until 23 illustrate various schemes of increasing complexity for reset pulses, FIGS. 16 and 17 showing schemes outside the scope of the invention, FIGS. 18 until 23 schemes within the scope of the invention.

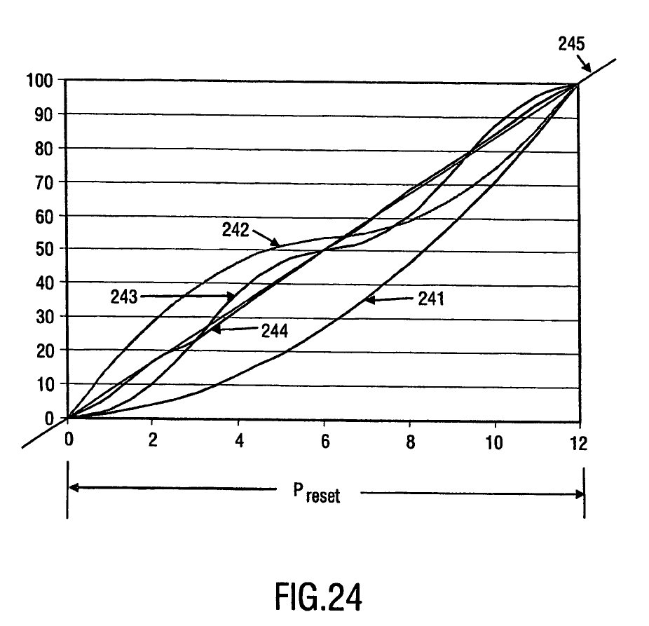

FIG. 24 illustrates the positive effect of the present invention.

In all the Figures corresponding parts are usually referenced to by the same reference numerals.

FIGS. 1 and 2 show an embodiment of the display panel 1 having a first substrate 8, a second opposed substrate 9 and a plurality of picture elements 2. Preferably, the picture elements 2 are arranged along substantially straight lines in a two-dimensional structure. Other arrangements of the picture elements 2 are alternatively possible, e.g. a honeycomb arrangement. An electrophoretic medium 5, having charged particles 6, is present between the substrates 8, 9. A first and a second electrode 3, 4 are associated with each picture element 2. The electrodes 3, 4 are able to receive a potential difference. In FIG. 2 the first substrate 8 has for each picture element 2 a first electrode 3, and the second substrate 9 has for each picture element 2 a second electrode 4. The charged particles 6 are able to occupy extreme positions near the electrodes 3, 4 and intermediate positions in between the electrodes 3, 4. Each picture element 2 has an appearance determined by the position of the charged particles 6 between the electrodes 3, 4 for displaying the picture. Electrophoretic media 5 are known per se from e.g. U.S. Pat. No. 5,961,804, U.S. Pat No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the picture element 2 is e.g. white. Here it is considered that the picture element 2 is observed from the side of the second substrate 9. When the charged particles 6 are in a second extreme position, i.e. near the second electrode 4, as a result of the potential difference being of opposite polarity, i.e. −15 Volts, the appearance of the picture element 2 is black. When the charged particles 6 are in one of the intermediate positions, i.e. in between the electrodes 3, 4, the picture element 2 has one of the intermediate appearances, e.g. light gray, middle gray and dark gray, which are gray levels between white and black. The drive means 100 are arranged for controlling the potential difference of each picture element 2 to be a reset potential difference having a reset value and a reset duration for enabling particles 6 to substantially occupy one of the extreme positions, and subsequently to be a picture potential difference for enabling the particles 6 to occupy the position corresponding to the image information.

FIG. 3 diagrammatically shows a cross section of a portion of a further example of an electrophoretic display device 31, for example of the size of a few display elements, comprising a base substrate 32, an electrophoretic film with an electronic ink which is present between two transparent substrates 33, 34 for example polyethylene, one of the substrates 33 is provided with transparent picture electrodes 35 and the other substrate 34 with a transparent counter electrode 36. The electronic ink comprises multiple micro capsules 37, of about 10 to 50 microns. Each micro capsule 37 comprises positively charged white particles 38 and negative charged black particles 39 suspended in a fluid F. When a positive field is applied to the pixel electrode 35, the white particles 38 move to the side of the micro capsule 37 directed to the counter electrode 36 and the display element become visible to a viewer. Simultaneously, the black particles 39 move to the opposite side of the microcapsule 37 where they are hidden to the viewer. By applying a negative field to the pixel electrodes 35, the black particles 39 move to the side of the micro capsule 37 directed to the counter electrode 36 and the display element become dark to a viewer (not shown). When the electric field is removed the particles 38, 39 remain in the acquired state and the display exhibits a bi-stable character and consumes substantially no power.

FIG. 4 shows diagrammatically an equivalent circuit of a picture display device 31 comprising an electrophoretic film laminated on a base substrate 32 provided with active switching elements, a row driver 46 and a column driver 40. Preferably, a counter electrode 36 is provided on the film comprising the encapsulated electrophoretic ink, but could be alternatively provided on a base substrate in the case of operation using in-plane electric fields. The display device 31 is driven by active switching elements, in this example thin film transistors 49. It comprises a matrix of display elements at the area of crossing of row or selection electrodes 47 and column or data electrodes 41. The row driver 46 consecutively selects the row electrodes 47, while a column driver 40 provides a data signal to the column electrode 41. Preferably, a processor 45 firstly processes incoming data 43 into the data signals. Mutual synchronisation between the column driver 40 and the row driver 46 takes place via drive lines 42. Select signals from the row driver 46 select the pixel electrodes 42 via the thin film transistors 49 whose gate electrodes 50 are electrically connected to the row electrodes 47 and the source electrodes 51 are electrically connected to the column electrodes 41. A data signal present at the column electrode 41 is transferred to the pixel electrode 52 of the display element coupled to the drain electrode via the TFT. In the embodiment, the display device of FIG. 3 also comprises an additional capacitor 53 at the location at each display element 48. In this embodiment, the additional capacitor 53 is connected to one or more storage capacitor lines 54. Instead of TFT other switching elements can be applied such as diodes, MIM's, etc.

As an example the appearance of a picture element of a subset is light gray, denoted as G2, before application of the reset potential difference. Furthermore, the picture appearance corresponding to the image information of the same picture element is dark gray, denoted as G1. For this example, the potential difference of the picture element is shown as a function of time in FIG. 5A. The reset potential difference has e.g. a value of 15 Volts and is present from time t₁ to time t′₂, t₂ being the maximum reset duration, i.e. the reset period Preset. The reset duration and the maximum reset duration e.g. 50 ms and 300 ms, respectively. As a result the picture element has an appearance being substantially white, denoted as W. The picture potential difference is present from time t₃ to time t₄ and has a value of e.g. −15 Volts and a duration of e.g. 150 ms. As a result the picture element has an appearance being dark gray (G1), for displaying the picture. The interval from time t2 to time t3 may be absent.

The maximum reset duration, i.e. the complete reset period, for each picture element of the subset is substantially equal to or more than to the duration to change the position of particles 6 of the respective picture element from one of the extreme positions to the other one of the extreme positions. For the picture element in the example the reference duration is e.g. 300 ms.

As a further example the potential difference of a picture element is shown as a function of time in FIG. 5B. The appearance of the picture element is dark gray (G1) before application of the reset potential difference. Furthermore, the picture appearance corresponding to the image information of the picture element is light gray (G2). The reset potential difference has e.g. a value of 15 Volts and is present from time t₁ to time t′₂. The reset duration is e.g. 150 ms. As a result the picture element has an appearance being substantially white (W). The picture potential difference is present from time t3 to time t4 and has e.g. a value of e.g. −15 Volts and a duration of e.g. 50 ms. As a result the picture element has an appearance being light gray (G2), for displaying the picture.

In another variation of the embodiment the drive means 100 are further arranged for controlling the reset potential difference of each picture element to enable particles 6 to occupy the extreme position which is closest to the position of the particles 6 which corresponds to the image information. As an example the appearance of a picture element is light gray (G2) before application of the reset potential difference. Furthermore, the picture appearance corresponding to the image information of the picture element is dark gray (G1). For this example, the potential difference of the picture element is shown as a function of time in FIG. 6A. The reset potential difference has e.g. a value of −15 Volts and is present from time t₁ to time t′₂. The reset duration is e.g. 150 ms. As a result, the particles 6 occupy the second extreme position and the picture element has a substantially black appearance, denoted as B, which is closest to the position of the particles 6 which corresponds to the image information, i.e. the picture element 2 having a dark gray appearance (G1). The picture potential difference is present from time t3 to time t4 and has e.g. a value of e.g. 15 Volts and a duration of e.g. 50 ms. As a result the picture element 2 has an appearance being dark gray (G1), for displaying the picture. As another example the appearance of another picture element is light gray (G2) before application of the reset potential difference. Furthermore, the picture appearance corresponding to the image information of this picture element is substantially white (W). For this example, the potential difference of the picture element is shown as a function of time in FIG. 6B. The reset potential difference has e.g. a value of 15 Volts and is present from time t₁ to time t′₂. The reset duration is e.g. 50 ms. As a result, the particles 6 occupy the first extreme position and the picture element has a substantially white appearance (W), which is closest to the position of the particles 6 which corresponds to the image information, i.e. the picture element 2 having a substantially white appearance. The picture potential difference is present from time t₃ to time t₄ and has a value of 0 Volts because the appearance is already substantially white, for displaying the picture.

In FIG. 7 the picture elements are arranged along substantially straight lines 70. The picture elements have substantially equal first appearances, e.g. white, if particles 6 substantially occupy one of the extreme positions, e.g. the first extreme position. The picture elements have substantially equal second appearances, e.g. black, if particles 6 substantially occupy the other one of the extreme positions, e.g. the second extreme position. The drive means are further arranged for controlling the reset potential differences of subsequent picture elements 2 along on each line 70 to enable particles 6 to substantially occupy unequal extreme positions. FIG. 7 shows the picture representing an average of the first and the second appearances as a result of the reset potential differences. The picture represents substantially middle gray.

In FIG. 8 the picture elements 2 are arranged along substantially straight rows 71 and along substantially straight columns 72 being substantially perpendicular to the rows in a two-dimensional structure, each row 71 having a predetermined first number of picture elements, e.g. 4 in FIG. 8, each column 72 having a predetermined second number of picture elements, e.g. 3 in FIG. 8. The picture elements have substantially equal first appearances, e.g. white, if particles 6 substantially occupy one of the extreme positions, e.g. the first extreme position. The picture elements have substantially equal second appearances, e.g. black, if particles 6 substantially occupy the other one of the extreme positions, e.g. the second extreme position. The drive means are further arranged for controlling the reset potential differences of subsequent picture elements 2 along on each row 71 to enable particles 6 to substantially occupy unequal extreme positions, and the drive means are further arranged for controlling the reset potential differences of subsequent picture elements 2 along on each column 72 to enable particles 6 to substantially occupy unequal extreme positions. FIG. 8 shows the picture representing an average of the first and the second appearances as a result of the reset potential differences. The picture represents substantially middle gray, which is somewhat smoother compared to the previous embodiment.

In variations of the device the drive means are further arranged for controlling the potential difference of each picture element to be a sequence of preset potential differences before being the reset potential difference. Preferably, the sequence of preset potential differences has preset values and associated preset durations, the preset values in the sequence alternate in sign, each preset potential difference represents a preset energy sufficient to release particles 6 present in one of the extreme positions from their position but insufficient to enable said particles 6 to reach the other one of the extreme positions. As an example the appearance of a picture element is light gray before the application of the sequence of preset potential differences. Furthermore, the picture appearance corresponding to the image information of the picture element is dark gray. For this example, the potential difference of the picture element is shown as a function of time in FIG. 9. In the example, the sequence of preset potential differences has 4 preset values, subsequently 15 Volts, −15 Volts, 15 Volts and −15 Volts, applied from time t₀ to time t′₀. Each preset value is applied for e.g. 20 ms. The time interval between t′₀ and t₁ is preferably relatively small. Subsequently, the reset potential difference has e.g. a value of −15 Volts and is present from time t₁ to time t′₂. The reset duration is e.g. 150 ms. As a result, the particles 6 occupy the second extreme position and the picture element has a substantially black appearance. The picture potential difference is present from time t₃ to time t₄ and has e.g. a value of e.g. 15 Volts and a duration of e.g. 50 ms. As a result the picture element 2 has an appearance being dark gray, for displaying the picture. Without being bound to a particular explanation for the mechanism underlying the positive effects of application of the preset pulses, it is presumed that the application of the preset pulses increases the momentum of the electrophoretic particles and thus shortens the switching time, i.e the time necessary to accomplish a switch-over, i.e. a change in appearance. It is also possible that after the display device is switched to a predetermined state e.g. a black state, the electrophoretic particles are “frozen” by the opposite ions surrounding the particle. When a subsequent switching is to the white state, these opposite ions have to be timely released, which requires additional time. The application of the preset pulses speeds up the release of the opposite ions thus the de-freezing of the electrophoretic particles and therefore shortens the switching time.

All of the foregoing figures and explanations relate to the general principle of applying reset pulses possibly with the addition of applying preset pulses.

As explained above, the accuracy of the greyscales in electrophoretic displays is strongly influenced by image history, dwell time, temperature, humidity, lateral inhomogeneity of the electrophoretic foils etc. Using reset pulses accurate grey levels can be achieved since the grey levels are always achieved either from reference black (B) or from reference white state (W) (the two extreme states). The pulse sequence usually consists of two to four portions: shaking pulses (optionally, hereinfurther also called shake 1), reset pulse, shaking pulses (optionally, hereinfurther also called shake 2) and greyscale driving pulse. A disadvantage of this method is the presence of a long delay time between creating the intermediate image (reset state) and introducing the grey levels into the display, i.e. the delay t′₂−t₃, in particular for the pixels requiring a shorter image update sequence e.g. for the transitions from a state close to an extreme state to an extreme state, e.g. from light grey to white or dark grey to black. This delay, or more in particular the difference in effective delay time between different elements results in a visually abrupt introduction of the grey levels (shock effect), which is visible to the viewer.

It is an object of the invention to provide a display panel of the kind mentioned in the opening paragraph which is able to provide a smoother change over from one image to another.

The object is thereby achieved that the drive means are further arranged for application of the reset potential difference for resetting a picture element from an optical state, e.g. intermediate grey scale (G1, G2) to an extreme position (B, W) in two or more pulses separated by a time period during the reset period (Pᵣₑₛₑₜ). Preferably, the pulses have the same polarity.

In the device in accordance with the invention, the drive means are arranged for driving schemes with at least two bits grey scale, in which at least some reset pulse is split into at least two short pulses separated by a time interval, particularly in relatively short image update sequences. These split short reset pulses more evenly fill in the time period (Pᵣₑₛₑₜ) required for the reset pulse in a longer image update sequence, resulting in a gradual image change. In this way, the delay between reset to black/white image and the addition of grey scales is minimized and a more natural/smooth image appearance is obtained. The total image update time remains substantially unchanged.

In preferred embodiment shaking pulses are also applied.

The invention will be further exemplified with reference to several embodiments.

### EMBODIMENT 1

Embodiment 1 of this invention is schematically shown in FIG. 10B, whereas FIG. 10A shows a driving scheme not in accordance with the invention. In this example, the display has at least 2-bits grey levels: Black (B), Dark grey (G1), Light grey (G2) and White (W). Two transitions to G1 state from W and G1 respectively are realized. A long sequence for the transitions from W to G1 and the short sequence for G1 to G1. Each sequence in FIGS. 10A and 10B consists of four portions: shake 1, reset, shake 2 and driving. Now, the single reset pulse in the short sequence (G1 to G1) of FIG. 10A is split into six short reset pulses for FIG. 10B, which are of equal length and distributed with an equal distance, i.e. separated by by equal time intervals, in the time period required for the reset pulse in the long transition sequence (W to G1), whilst the single reset pulse in the long sequence remains unchanged. In this example, the sum of the pulse time in these short pulses is for simplicity taken to be equal to the pulse width of the original single reset pulse. Due to non-linearity character of the ink response to the voltage impulse, it is possible that the sum of the pulse time in these short pulses deviates from (usually longer than) the pulse width of the single reset pulse, in order to reach the well-defined reset optical state. The delay between reset black state and the addition of grey scales is now minimized and a more natural image appearance is obtained without increase of the total image update time. The splitting of pulses and the distribution over the reset period alleviates or at least reduces the mentioned shock effect.

Within this scheme transitions from G2 (light grey) to G1 (dark grey) may be achieved by applying a reset pulse of length intermediate to the shown length (i.e. longer than the transition from G1 to B, but shorter than from W to B) respectively not using a reset pulse. The reset pulse G2-B would then be split into e.g. 8 or 9 short pulses or 2 to 3 relatively long pulses.

Alternatively the driving scheme may be simplified by using the concept of overreset, i.e. intentionally overdriving the element into the extreme state.

This is illustrated in FIGS. 11A, 11B in which four transitions to G1 state from W, G2, G1, B are realized using two types of pulse sequences when over-reset is used for resetting the display in so far as the original state is G2 (light grey) and B (black): Long sequence for the transitions from G2 or W to G1 (i.e. the same length for both G2 and W, which for G2 means application of an overreset) and the short sequence for Gl or B to G1 (which for B means application of an overreset, since strictly speaking a black original state does not need application of a reset pulse to a black state). Each sequence consists of four portions: shake 1, reset, shake 2 and driving. Now, the single reset pulse in the short sequence (G1/B to G1) is split into six short reset pulses, which are distributed with an equal distance in the time period required for the reset pulse in the long transition sequence (G2/W to G1), whilst the single reset pulse in the long sequence remains unchanged.

### EMBODIMENT 2

The embodiment 2 of this invention is schematically shown in FIG. 12, in which the six short reset pulses with equal pulse width are distributed with unequal distance in the time period required for the reset pulse in the long transition sequence (G2/W to G1), whilst the single reset pulse in the long sequence remains unchanged.

### EMBODIMENT 3

The embodiment 3 of this invention is schematically shown in FIG. 13, in which the reset pulse in the short sequence for G1 or B to G1 transitions is split into four short reset pulses with unequal pulse width, which are distributed with unequal distance in the time period required for the reset pulse in the long transition sequence (G2/W to G1), whilst the single reset pulse in the long sequence remains unchanged.

### EMBODIMENT 4

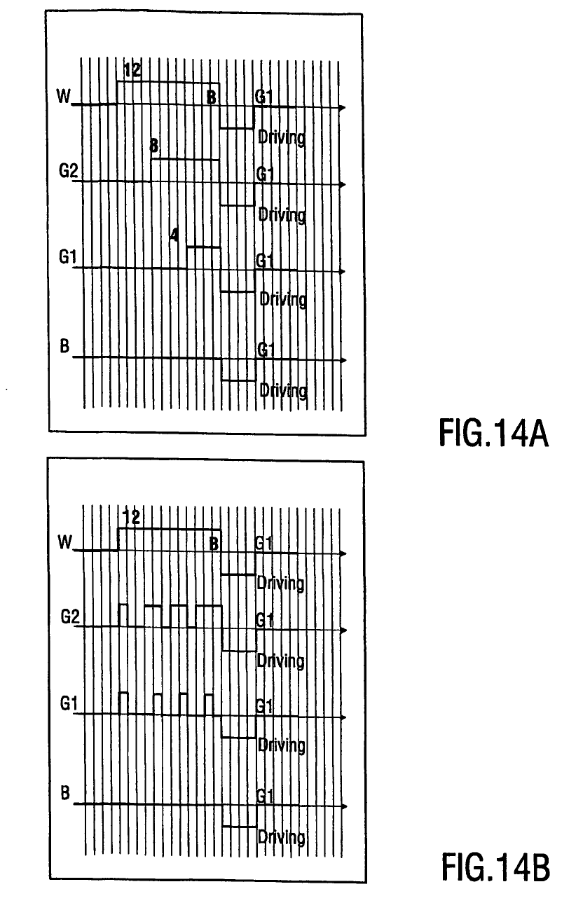

The embodiment 4 of this invention is schematically shown in FIG. 14B, in which the length of reset pulses used in various sequences is proportional to the distance required for the ink to move in the vertical direction. For comparison, the original waveforms not according to this invention are also shown in FIG. 14A. For example, in a pulse width modulated driving, the full pulse width (FPW) is required for resetting the display from white to black but only ⅔ of the FPW is needed from G2 to black and ⅓ of the FPW from G1 to black. Shaking pulses are not applied. These waveforms are usable when e.g. transition matrix-based driving methods are used, in which previous images are considered in determination of the impulses (time×voltage) for next image. Also, these waveforms may be used when the ink materials used in the display are insensitive to the image history and/or dwell time. Again, the single reset pulse in the short sequences from G2, G1 and B to G1 (FIG. 14A) are split into a few short reset pulses (FIG. 14B) with unequal pulse width, which are distributed with an unequal distance in the time period required for the reset pulse in the long transition sequence (W to G1), whilst the single reset pulse in the long sequence remains unchanged. For simplicity, the sum of the pulse time in these short pulses is again taken to be equal to the pulse width of the original single reset. The delay between reset black state and the addition of grey scales is now minimized and a more natural image appearance is obtained without increase of the total image update time.

### EMBODIEMENT 5

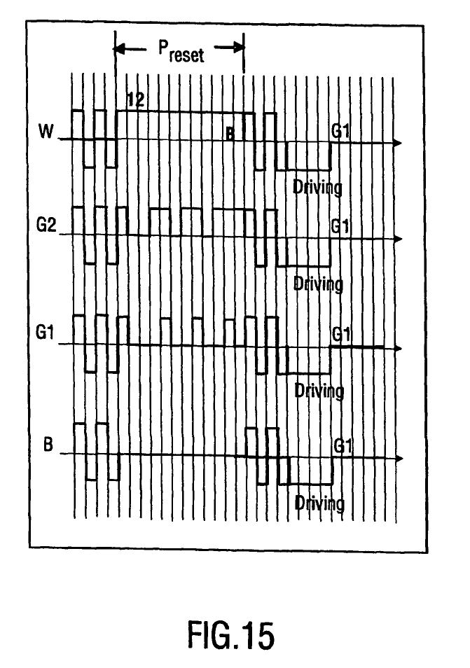

The embodiment 5 of this invention is schematically shown in FIG. 15, in which two sets of shaking pulses are applied prior to the reset pulse and prior to the driving pulse based on the driving waveforms of embodiment 4. These shaking pulses can effectively reduce the effects of dwell time and/or image history. This means a significant reduction of the number of previous image states when transition matrix-based driving methods are used. These shaking pulses are particularly necessary when the ink materials used in the display are sensitive to the image history and/or dwell time.

FIG. 16 up until 23 illustrate various schemes, of increasing complexity, for reset pulses.

FIG. 16 and all further figures are schematic illustration of application of reset pulse, in which the grey areas indicate application of reset voltage (e.g. +15 , −15 Volt) and a white area indicates a zero voltage. Along the horizontal axis the time is given, wherein the reset period (Pᵣₑₛₑₜ) is divided into 12 steps in these examples. Vertically various schemes are schematically indicated, in the first FIG. 16 a quite complicated scheme is illustrated in which there are 12 grey levels (as much grey levels as there are sub-divisions in the reset time period Pᵣₑₛₑₜ). It is then possible to reset between 13 levels, i.e. White (W), Black (B) and eleven grey levels (G1 to G11) in between. FIG. 16 shows a scheme in which each reset pulse is a single pulse. The left hand part of the figure illustrates a scheme in which all reset pulses are given from the start of the reset period, the right hand part of the figure gives a scheme in which all reset pulses are given near the end of the reset period.

FIG. 17 illustrates various schemes 16A to 16H in which the number of grey levels has been reduced. Scheme 16D corresponds to the scheme of FIG. 14A. In all of these schemes the reset pulses are single reset pulses concentrated either at the beginning of the reset period (left hand side of the figure) or near the end (right hand side). The scheme of FIGS. 16 and 17 do not fall under the scope of the invention, since the reset pulses are all single reset pulses.

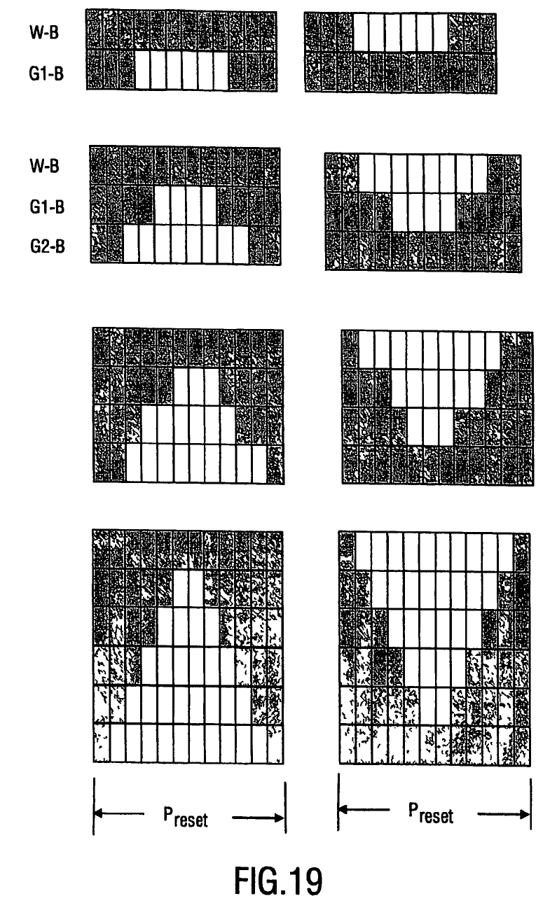

FIG. 18 illustrates a scheme in accordance with the invention. The reset period is divided into 12 time fixed time periods. Comparing the scheme of FIG. 18 with that of FIG. 16 is clear that, apart from very long or very short reset pulses, the reset pulses for many transitions are split in two sub-reset pulses separated by periods in which a zero voltage pulse is applied. FIG. 18 shows the most complex scheme, FIG. 19 schemes in which less grey levels are used. In each of the schemes for at least one transition from an optical state to an extreme optical state two or more (in this case two) pulses are applied, separated by a non-zero (in this case only one) time interval. Very long or very short pulses, i.e. having a length below an upper threshold (in this case depending on the scheme 8 to 12 are still applied in one single pulse. Many of the schemes schematically shown in FIG. 19 show that the length of the reset pulses is equal for all transitions (e.g. the top most schemes, the ones below that, and the bottom most schemes).

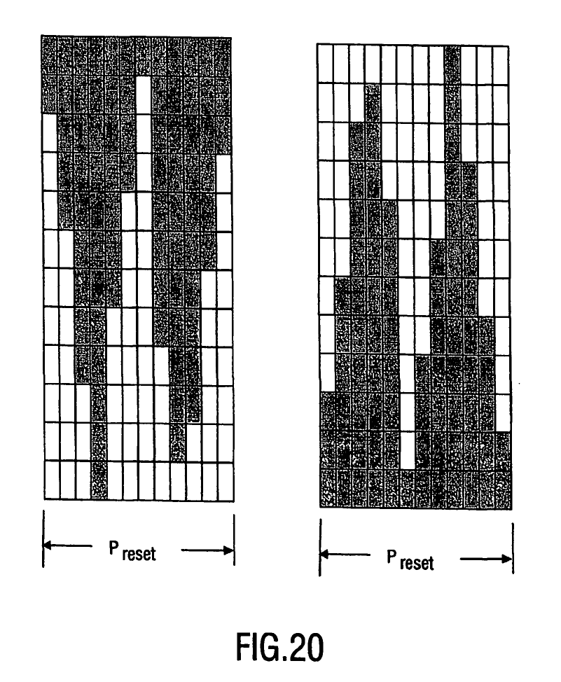

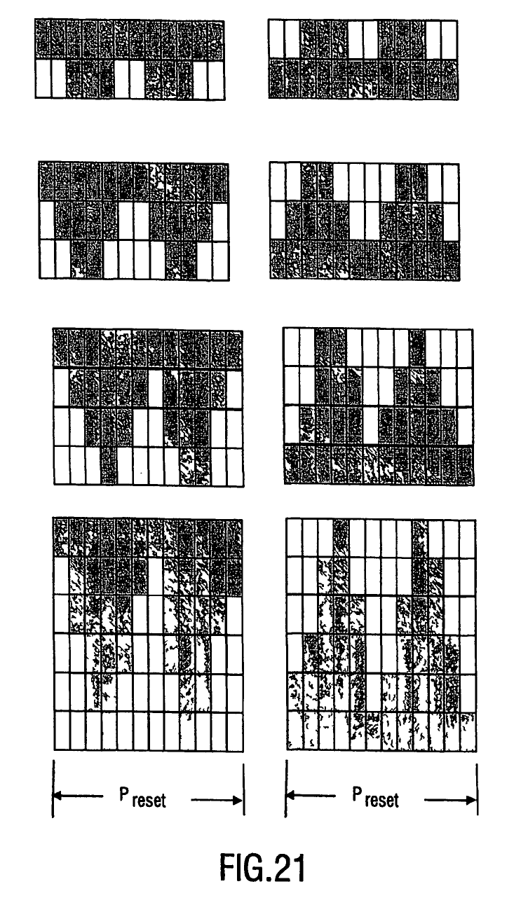

FIGS. 20 and 21 illustrate further, more preferred embodiments of the invention. In these schemes the reset pulses are split in two, as in FIGS. 18 and 19, but, whereas in FIGS. 18 and 19 the sub-reset pulses start and end at the beginning and end of the reset period Pᵣₑₛₑₜ, in the scheme in FIGS. 20 and 21, the sub-reset pulses, at least for some reset transitions, are concentrated around 25% and 75% of the reset period. Again, as for FIGS. 18 and 19, in each of the schemes for at least one transition from an optical state to an extreme optical state two or more (in this case two) pulses are applied, separated by a non-zero (in this case only one) time interval. Very long or very short pulses, i.e. having a length below an upper threshold (in this case depending on the scheme 8 to 12) and above a lower threshold (0 or 1 in this case) are applied in one single, very short or very long, pulse. Many, in fact three of the four of the schemes schematically shown in FIG. 21 show that the length of the reset pulses is equal for all transitions.

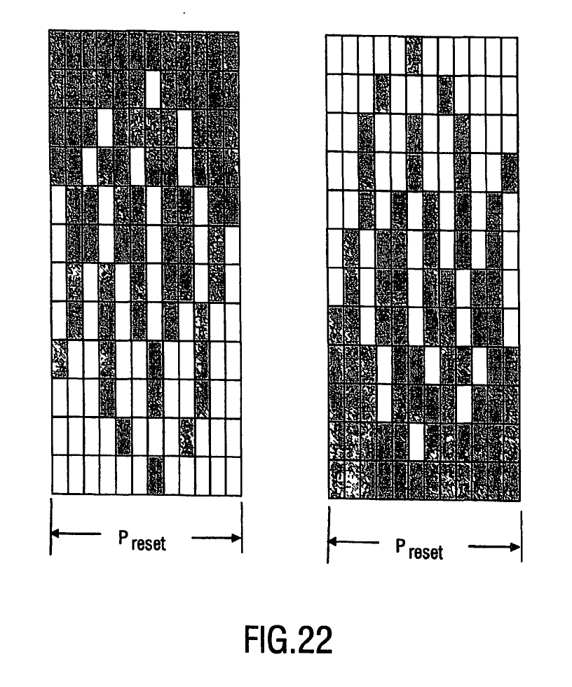

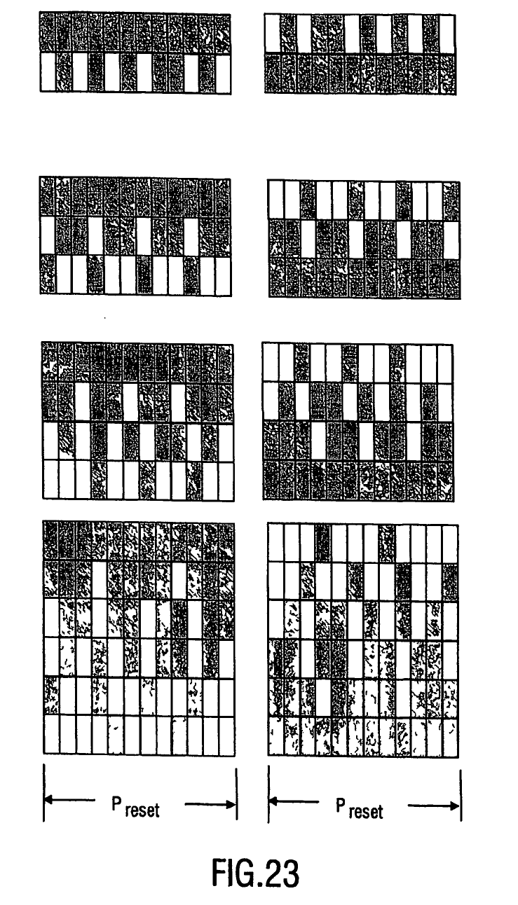

FIGS. 22 and 23 finally illustrate an even more preferred embodiment of the invention in which the split reset pulses are more even evenly distributed over the reset period.

FIG. 24 illustrate the effect of the present invention in a graphical form. On the horizontal axis the reset period divided in 12 (in this example) frame times is given, on the vertical axis the averaged accomplished amount of reset (in percentage) is indicated. In the schemes in FIGS. 16 and 17 the major part of the reset is done either directly after the start of the reset period or immediately prior to the end of the reset period, the latter condition being illustrated by line 241 in the figure. It is apparent that the major part of the reset is done in a short period of time near the end of the reset period, which accounts for the shock effect. Splitting the reset pulses into two, as illustrated in FIGS. 18 and 19, reduces this effect, as is illustrated by line 242 in FIG. 24. Although this reduces the shock effect considerably (parts of the reset are done near the beginning as well as near the end of the reset period) some shock effect is apparent near the beginning and the end of the reset period. Line 243 illustrates the effect of schemes such as illustrated in FIGS. 20 and 21. A smooth transition close to the ideal line (line 245) is established. Therefore concentrating the two pulses around 25% and 75% of the reset period improves the display. An even smoother transition (line 244) is possible by application of more than two pulses (FIGS. 22 and 23).

Therefore splitting the reset pulse into multiple short reset pulses provides for a smoother transition and a decrease in the shock effect. Since splitting of the reset pulses costs energy, the best solution depends on a trade-off between energy requirements and smoothing effect. Depending on this trade-off in embodiments the reset pulse may be split into two, three or more short pulses.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The invention is also embodied in any computer program comprising program code means for performing a method in accordance with the invention when said program is run on a computer as well as in any computer program product comprising program code means stored on a computer readable medium for performing a method in accordance with the invention when said program is run on a computer, as well as any program product comprising program code means for use in display panel in accordance with the invention, for performing the action specific for the invention.

The present invention has been described in terms of specific embodiments, which are illustrative of the invention and not to be construed as limiting. The invention may be implemented in hardware, firmware or software, or in a combination of them. Other embodiments are within the scope of the following claims.

It will be obvious that many variations are possible within the scope of the invention without departing from the scope of the appended claims.

1. An electrophoretic display panel (1), comprising:
an electrophoretic medium (5) comprising charged particles (6);
a plurality of picture elements (2);
electrodes (3, 4) associated with each picture element (2) for receiving a potential difference; and
drive means (100), the drive means (100) being arranged for controlling the potential difference of each picture element (2)
to be a reset potential difference having a reset value and a reset duration for enabling particles (6) to substantially occupy one of the extreme positions, and subsequently
to be a picture potential difference for enabling the particles (6) to occupy the position corresponding to the image information, characterized in that the drive means (100) are further arranged for application of the reset potential difference for resetting a picture element from one optical state to an extreme optical state in two or more pulses separated by a non-zero time interval during a reset period (Pᵣₑₛₑₜ).

2. An electrophoretic display panel as claimed in claim 1 characterized in that the drive means are arranged for application of the two or more pulses whereby the two or more pulses have the same polarity.

3. An electrophoretic display panel as claimed in claim 1, characterized in that the drive means are arranged for application of the reset potential difference for resetting a picture element from an intermediate optical state to an extreme optical state in two or more pulses separated by a non-zero time interval during a reset period (Pᵣₑₛₑₜ).

4. An electrophoretic display panel as claimed in claim 1, characterized in that the reset potential difference for resetting a picture element from one optical state to an extreme optical state is applied in two or more pulses during the reset period (Pᵣₑₛₑₜ) for image transitions with a total reset potential application time shorter than a upper threshold and longer than a lower threshold.

5. An electrophoretic display panel as claimed in claim 1, characterized in that the drive means (100) are further arranged for application of the reset potential difference for resetting a picture element from an optical state to an extreme optical state in more than two pulses during the reset period (Pᵣₑₛₑₜ).

6. An electrophoretic display panel as claimed in claim 1, characterized in that the drive means (100) are further arranged for application of the reset potential difference for resetting a picture element from an optical state to an extreme optical state in two pulses during the reset period (Pᵣₑₛₑₜ).

7. An electrophoretic display, panel as claimed in claim 6, characterized in that the pulses are concentrated around 25% and 75% of the reset period.

8. An electrophoretic display panel as claimed in claim 1, characterized in that the drive means are arranged for application of the reset potential difference in two or more pulses wherein the applied pulses have, for the transition from at least one intermediate optical state to an extreme state, substantially equal time duration.

9. An electrophoretic display panel as claimed in claim 1, characterized in that the drive means are arranged for application of the reset potential difference in two or more pulses wherein, for the transition of at least one intermediate optical state to an extreme optical state, the pulses are separated by at least two non-zero time intervals, and the time intervals are of substantially equal length.

10. An electrophoretic display panel as claimed in claim 1, characterized in that the drive means are further arranged to control for each picture element the potential difference to be a sequence of preset potential differences before being the reset potential difference, the sequence of preset potential differences having preset values and associated preset durations, the preset values in the sequence alternating in sign, each preset potential difference representing a preset energy sufficient to release particles present in one of said extreme positions from their position but insufficient to enable said particles to reach the other one of the extreme positions.

11. A method for driving an electrophoretic display device comprising:
an electrophoretic medium (5) comprising charged particles (6);
a plurality of picture elements (2), in which method reset pulses are applied to elements of the display device, prior to application of grey scale data, for resetting picture elements characterized in that the reset potential difference for resetting a picture element from an optical state to an extreme optical state is applied in two or more pulses separated by a non-zero time interval during a reset period (Pᵣₑₛₑₜ).

12. A method as claimed in claim 11, characterized in that the reset potential difference for resetting a picture element from an optical state to an extreme optical state is applied in more than two pulses during the reset period (Pᵣₑₛₑₜ).

13. A method as claimed in claim 11, characterized in that the reset potential difference for resetting a picture element from an optical state to an extreme optical state is applied in two pulses during the reset period (Pᵣₑₛₑₜ).

14. Drive means (100) for driving an electrophoretic display panel (1), said display panel (l) comprising:
an electrophoretic medium (5) comprising charged particles (6);
a plurality of picture elements (2); and
electrodes (3, 4) associated with each picture element (2) for receiving a potential difference; said drive means (100) being arranged for controlling the potential difference of each picture element (2)
to be a reset potential difference having a reset value and a reset duration for enabling particles (6) to substantially occupy one of the extreme positions, and subsequently
to be a picture potential difference for enabling the particles (6) to occupy the position corresponding to the image information, said drive means (100) being further arranged for application of the reset potential difference for resetting a picture element from one optical state to an extreme optical state in two or more pulses separated by a non-zero time interval during a reset period (Pᵣₑₛₑₜ).
